(19) United States
(12) Patent Application Publication
(10) Pub. No.: US 2017/0291490 A1
(43) Pub. Date: Oct. 12, 2017

(54) AUTOMOBILE ROOF PANEL HAVING SOLAR CELLS

(71) Applicant: HYUNDAI MOTOR COMPANY, Seoul (KR)

(72) Inventors: Ji Yong LEE, Suwon-si (KR); Moon Jung EO, Suwon-si (KR); Sung Geun PARK, Seoul (KR)

(21) Appl. No.: 15/270,745

(22) Filed: Sep. 20, 2016

(30) Foreign Application Priority Data
Apr. 7, 2016 (KR) 10-2016-0042892

(51) Int. Cl. B60K 16/00; B60L 8/00; H02S 10/40

(52) U.S. Cl. CPC B60K 16/00; H02S 10/40; B60L 8/003; B60K 2016/003; B60Y 2200/912; B60Y 2200/92; B60Y 2304/00; B60Y 2400/216

(57) ABSTRACT

An automobile roof panel including solar cells, wherein a seating groove for seating a solar cell module is formed on a surface of the automobile roof panel, the solar cell module is inserted and seated in the seating groove, and an outer protective film for protecting the solar cell module is attached onto the surface of the automobile roof panel.

### CROSS-REFERENCE TO RELATED APPLICATION

This application claims under 35 U.S.C. §119(a) the benefit of priority to Korean Patent Application No. 10-2016-0042892, filed on Apr. 7, 2016 with the Korean Intellectual Property Office, the entire contents of which are incorporated herein by reference.

### TECHNICAL FIELD

The present disclosure relates to an automobile roof panel having solar cells. More particularly, it relates to an automobile roof panel to which solar cells are applied without changing a design of an automobile body by inserting and seating a solar cell module in a roof panel, that is, a roof steel plate and wrapping an outer protective film on the entire roof panel.

### BACKGROUND

High-power solar cells have different components and structures in accordance with the type of solar cell, but generally include a part which generates electrons by receiving sunlight, and a collector electrode part which moves the generated and/or collected electrons to a bus bar (a part connected to an electric wire along which electric current flows as the electrons are collected and moved to an anode and a cathode). If the solar cell has a predetermined area or larger, a loss of generated electrons occurs due to electron movement resistance in the material itself, which causes a decrease in generated power. Therefore, a collector electrode is required to collect the generated electrons at predetermined intervals and move the electrons to the bus bar.

Meanwhile, a steel plate for an automobile to which the solar cell may be applied may be broadly used for a bonnet, a front fender, a roof, a door, a trunk door and/or a quarter panel. In a case in which the solar cell is applied to the bonnet, the bonnet may have a large area and an appropriate angle for gathering sunlight, but generated power of the solar cell is greatly reduced due to heat transferred from an engine room. In a case in which the solar cell is applied to the trunk door, power is not decreased by heat, but because the trunk door has a small area, it is difficult to obtain sufficient power. In a case in which the solar cell is applied to the front fender, the door, or the quarter panel, power is not decreased by heat, and the front fender, the door, or the quarter panel has a sufficient area, but a great loss of power occurs because the front fender, the door, or the quarter panel is positioned in parallel with a direction of sunlight. Thus, an effective location includes the solar cell being applied to the roof which has a large area, reduced losses of power due to heat and an appropriate angle for sunlight.

However, in a case in which the high- power solar cell is applied to the automobile steel plate, it is possible to reduce restriction due to transparency, restriction due to surface curvature, or restriction due to a color in comparison with a case in which a semi-transparent solar cell is applied to a roof glass.

Therefore, the solar cell may be applied to the roof steel plate in order to obtain higher power in comparison with a case in which the solar cell is applied to roof glass.

If the solar cell is merely applied to the existing roof steel plate, a dimension of a portion formed from a windshield glass to a roof is changed due to a design of an automobile body, which causes problems in that noise occurs because of a change in direction of wind while the automobile travels. This may cause driving resistance, and the solar cell may be damaged due to the driving resistance, and a secondary accident may occur when the solar cell is separated due to a weakened joint. Thus, the solar cell may be applied without changing a design of an entire automobile body.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art and to manufacture a solar cell as a buried type solar cell to be inserted into a roof steel plate, and protect the solar cell by applying a protective film to an outermost layer of the roof steel plate into which the solar cell is inserted. The solar cell may be finished by using the existing tempered glass, but a process of reproducing a shape of the tempered glass corresponding to a curvature of an automobile body is additionally required. However, by using the protective film, it is possible to simplify a manufacturing process by omitting the reproducing process, and it is possible to reduce a weight by omitting the tempered glass. In addition, in a case in which the tempered glass is applied, there is a risk that a portion to which the solar cell is attached may be blown to the outside when the solar cell is scattered. In contrast, in a case in which the protective film is applied, it is possible to prevent scattering of the solar cell even though the solar cell is damaged by impact as described above, and according to features as described below, in a case in which the film is applied, the solar cell is generally dented at the outside of the roof without penetrating the interior of the automobile even though the solar cell is damaged. Therefore, it is possible to solve a problem which is caused by scattering of the solar cell due to damage caused by impact. In the present disclosure, a film, which is lower in price and lighter in weight than tempered glass and may be applied without modifying the automobile body shape, is used.

The present disclosure has been made in an effort to provide an automobile roof panel having solar cells, in which a seating groove for seating a solar cell module is formed on a surface of the roof panel, the solar cell module is inserted and seated in the seating groove, and an outer protective film for protecting the solar cell module is attached onto the surface of the roof panel.

In one aspect, the present disclosure provides an automobile roof panel including solar cells, in which a seating groove for seating a solar cell module is formed on a surface of the automobile roof panel, the solar cell module is inserted and seated in the seating groove, and a first protective film for protecting the solar cell module is attached onto the surface of the automobile roof panel.

According to the automobile roof panel having solar cells according to the present disclosure, it is possible to reduce restrictions due to transparency, restrictions due to a curvature, or restrictions due to a color in comparison with a case in which a semi-transparent solar cell is applied to a roof glass.

It is possible to provide the solar cell integrated with the automobile body in order to apply the solar cell without changing a design of the existing automobile body, improve fuel economy and obtain power required for other electrical power systems.

Other aspects and preferred embodiments of the disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuel derived from resources other than petroleum). As referred to herein, a hybrid vehicle is a vehicle that has two or more sources of power, for example both gasoline-powered and electric-powered vehicles.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view illustrating a cross-sectional view of an automobile roof panel having solar cells according to embodiments of the present disclosure;

FIG. 2 is a view illustrating a solar cell module according to exemplary embodiment 1 of the present disclosure;

FIG. 3 is a view illustrating parts of a solar cell module according to exemplary embodiment 2 of the present disclosure;

FIG. 4a is a view illustrating a solar cell module according to exemplary embodiment 3-1 of the present disclosure;

FIG. 4b is a view illustrating a solar cell module according to exemplary embodiment 3-2 of the present disclosure;

FIG. 5 is a view illustrating a solar cell module according to exemplary embodiment 4 of the present disclosure;

FIG. 6 is a side view of a roof panel having a seating groove according to the present disclosure;

FIG. 7 is a cross-sectional view of a roof panel having a seating groove according to an embodiment of present disclosure; and

FIG. 8 is a view illustrating a finishing material and a groove formed between an automobile roof panel and a solar cell module according to an embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers may refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

Hereinafter, the present disclosure will be described in more detail as one exemplary embodiment.

The present disclosure relates to an automobile roof panel having solar cells, which may include a solar cell module inserted into a steel plate used for the automobile roof panel and wrapped in a protective film. In the present specification, the ‘steel plate’ also means a ‘panel’.

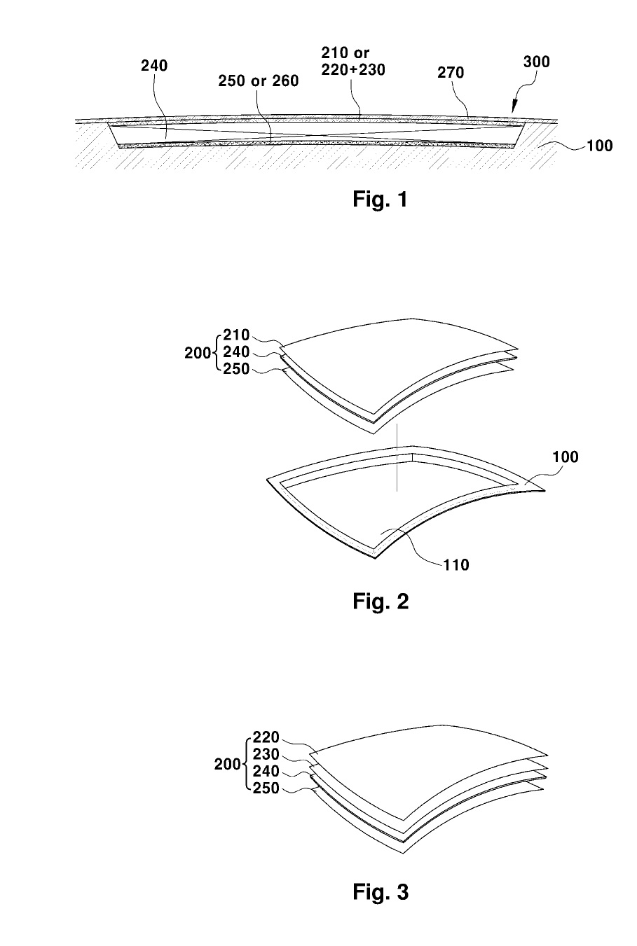

Specifically, as illustrated in FIG. 1, an automobile roof panel 300 having solar cells may include an automobile roof panel, or roof panel 100 which has a seating groove 110, a solar cell module 200 inserted and seated in the seating groove 110, and an outer protective film 270 wrapped on the entirety of the roof panel including the solar cell module 200 and the roof panel 100. Hereinafter, the solar cell module 200 will be described in detail.

FIG. 2 is a view illustrating the solar cell module 200 according to exemplary embodiment 1 of the present disclosure.

In FIG. 2, a first protective film 210 may be attached onto one surface of a solar cell 240 of the solar cell module 200, and a second protective film 250 may be attached onto the other surface of the solar cell 240. In this case, the first protective film 210 may be positioned on an outermost layer of an automobile, and the second protective film 250 may be positioned at a bottom side of the solar cell module which abuts on the seating groove.

The first protective film 210 may be a film which protects the solar cell from the outside, prevents scattering of the solar cell when the solar cell is damaged, and eliminates heterogeneity with an automobile body, and ensures properties resistant to scratches, which are similar to properties of the steel plate, by using a hard coating at 6H or higher, and to prevent chipping caused by impacts of foreign substances such as a small stone bounced and blown from a wheel or the outside when the automobile travels. In addition, the first protective film 210 has moisture transmission of 10⁰g/m² day or lower in order to maintain solar cell performance. Moisture transmission barrier coating may be carried out as necessary. In addition, the first protective film 210 has a thickness of 150 μm or larger, and as a material of the first protective film 210, a polyethylene terephthalate (PET) film or a polyvinyl chloride (PVC) film may be used among various types of polymeric films.

The second protective film 250 is black, which is the color of the solar cell, in order to package the solar cell and eliminate heterogeneity between the color of the solar cell and the color of the automobile body. The second protective film 250 has an adhesive component so as to be attached to the automobile body. At least one polymeric film, which is selected from the group consisting of a polyethylene terephthalate (PET), a polycarbonate (PC) film, a polyethylene naphthalate (PEN) film, a polyimide (PI) film, a polytetrafluoroethylene (PTFE) film, a polychlorotrifluoroethylene (PCTFE) film, a polyvinylidene fluoride (PVDF) film and an acrylic film, which has the adhesive component, may be applied. It may be advantageous to use the polyethylene terephthalate (PET) film and the acrylic film which are low in price.

FIG. 3 illustrates a solar cell module 200 according to exemplary embodiment 2 of the present disclosure, in which a polycarbonate (PC) film 220 and an adhesive film 230 are used as a first protective film 210.

The polycarbonate (PC) film 220 is one of the types of sheets having a thickness of 0.5 mm or larger. The first protective film may be substituted in order to protect the solar cell from the outside better than the first protective film in exemplary embodiment 1 of the present disclosure. In addition, a hard coating is required for a surface contacting the outside, and primer coating is required for an inner surface so as to ensure joining force with the film attachable to the solar cell. The barrier coating for preventing moisture transmission may be applied to any one of the surfaces of the polycarbonate (PC) film.

As the adhesive film 230, a polyvinylbutyral (PVB) film, an ethylene-vinyl acetate copolymer (EVA) film or films which may be attached by heat and/or compression, may be used.

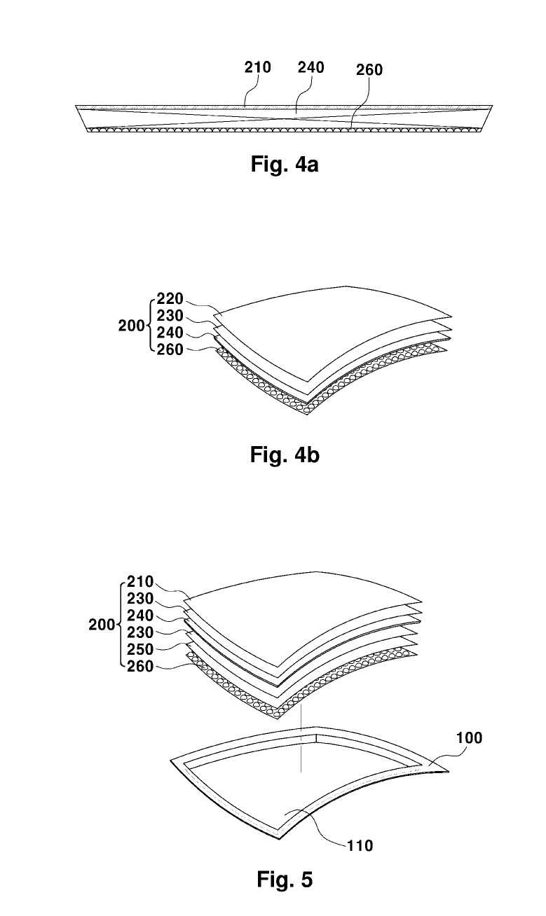

FIG. 4A illustrates exemplary embodiment 3-1 of the present disclosure in which an embossing film 260 is used as the second protective film 250 in exemplary embodiment 1 of the present disclosure, and FIG. 4B illustrates exemplary embodiment 3-2 of the present disclosure in which the embossing film 260 is used instead of the second protective film 250 in exemplary embodiment 2 of the present disclosure.

The embossing film 260 is a film which absorbs impacts in order to prevent the solar cell from being damaged by vibrations and impacts of the automobile body. The embossing film may have a surface having an uneven design (may have various shapes), and serves to absorb impacts or heat. In addition to the embossing film, an elastomer such as polydimethylsiloxane (PDMS) may be applied, and the elastomer has an elasticity at a predetermined thickness, thereby preventing the brittle solar cell from being damaged by vibrations and impacts of the automobile body. The lower end film includes an adhesive component so as to be attached to the solar cell and the automobile body.

FIG. 5 illustrates a solar cell module 200 according to exemplary embodiment 4 of the present disclosure, in which like exemplary embodiment 1 in FIG. 2, a first protective film 210 is positioned on one surface of the solar cell 240, a second protective film 250 is positioned on the other surface of the solar cell 240, an adhesive film 230 is present between the solar cell 240 and the first protective film 210, and an adhesive film 230 is present between the solar cell 240 and the second protective film 250. In a case in which the first protective film 210 and the second protective film 250 have no adhesive component, the solar cell module 200 is configured by using the adhesive film 230.

In this case, the first protective film 210 is positioned on an outermost layer of an automobile, and the second protective film 250 is positioned at a bottom side of the solar cell module which abuts the seating groove.

Like exemplary embodiment 1, the first protective film 210 is a film which protects the solar cell from the outside, prevents scattering of the solar cell when the solar cell is damaged, and eliminates heterogeneity with an automobile body, and the first protective film 210 ensures properties resistant to scratches, which are similar to properties of the steel plate, by using a hard coating at 6H or higher. Furthermore, because the second protective film 250 is a portion that abuts the seating groove, a function of the second protective film 250, which protects the solar cell from the outside, is less than a function of the first protective film 210, and as a result, the second protective film 250 is hard coated with a hardness of 3 to 6H, particularly, 4H, thereby ensuring properties resistant to scratches when the second protective film 250 is processed and conveyed. Furthermore, in the case of the first protective film 210 and the second protective film 250, a primer coating is required to ensure joining force with the adhesive film 230. Further, in exemplary embodiment 4 in FIG. 5, an embossing film 260, which is attachable at both surfaces, may be further inserted into the seating groove in order to insert and attach the solar cell module 200 in the seating groove.

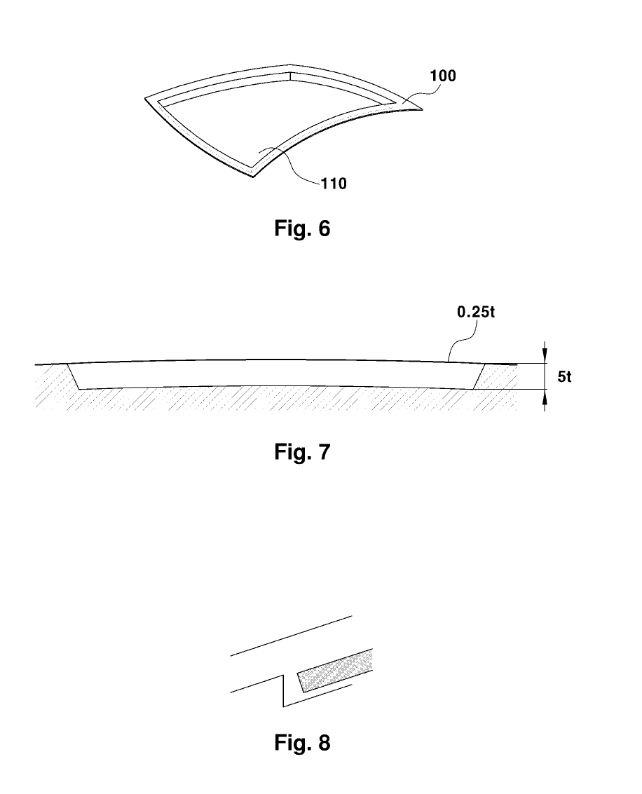

FIG. 6 is a side view of the roof panel into which the solar cell module 200 according to exemplary embodiment 1 to exemplary embodiment 4 according to the present disclosure may be seated and inserted. Further, FIG. 7 is a cross-sectional view when viewing a side of the roof panel.

To apply the solar cell module 200 according to exemplary embodiments 1 to 4 without changing a design of an external shape, the seating groove 110 may be formed by performing a press process on the automobile body to obtain a thickness as large as a thickness of the solar cell module 200. At the outer periphery of the roof panel 100, the steel plate is processed by pressing at a thickness of 1 to 5.0 mm within 10 mm, the solar cell module 200 is inserted into the space, that is, the seating groove 110, and then the entirety of the roof panel 100 is attached by the outer protective film 270, thereby eliminating heterogeneity with the peripheral portion. In this case, the outer protective film 270 may be the same as the first protective film 210 of the solar cell module, and specifically, may be made of at least one polyethylene (PE)-based material selected from the group consisting of polyvinyl chloride (PVC), an ethylene-vinyl acetate copolymer (EVA), high density polyethylene (HDPE), low density polyethylene (LDPE), linear low density polyethylene (LLDPE) and very low density polyethylene (VLDPE).

Since a space is present between a roof mat and the roof panel, no interior noise and the like occurs because there is no change in design even in the automobile. The following Table 1 shows a maximum thickness layer that may be formed at each layer, and the thickness of the seating groove 110 may be in the range of 1 to 5.0 mm.

TABLE 1

| | | Second | | | First | | Outer |
|---|---|---|---|---|---|---|---|
| | Embossing | Protective | Solar | Adhesive | Protective | Polycarbonate | Protective |
| Classification | Film | Film | Cell | Film | Film | Film | Film |
| (within) | 0.25 | 0.29 | 0.15~0.5 | 0.38~0.76 | 0.29 | 0.5~2.2 | 0.15~0.25 |
| Thickness | | | | | | | |
| (mm) | | | | | | | |

In the present disclosure, a finishing material configured as an epoxy or a rubber bearing may be attached to a groove formed between the automobile roof panel 100 and the solar cell module 200 in order to prevent damage and noise caused by contact between different types of materials. FIG. 8 illustrates the finishing material and the groove formed between the automobile roof panel and the solar cell module.

Therefore, the present disclosure, in which the solar cell is integrated with the automobile body without changing a design of the automobile body, may be widely used as the automobile roof panel having solar cells which solves the problems of restriction due to transparency, restriction due to a curvature, and restriction due to a color, and problems with stability such as scattering, which was problematic when applying the semi-transparent solar cell on the roof glass.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. An automobile roof panel including solar cells,
wherein a seating groove for seating a solar cell module formed on a surface of the automobile roof panel, the solar cell module is inserted and seated in the seating groove, and an outer protective film for protecting the solar cell module is attached onto the surface of the automobile roof panel,
wherein a depth of the seating groove is 1 to 5 mm,
the solar cell module, which abuts on the seating groove, has a first protective film, a solar cell and a second protective film which are sequentially layered,
the first protective film includes
a polymer material that includes polycarbonate (PC) and
an adhesive component in the polymer material,
wherein a finishing material including an epoxy or rubber bearing is attached in a gap between the seating groove and the solar cell module.

2. (canceled)

3. The automobile roof panel of claim 1, wherein the solar cell module further includes an adhesive film between the solar cell and the second protective film.

4. The automobile roof panel of claim 1, wherein the first protective film further includes a polyethylene terephthalate (PET) film or a polyvinyl chloride (PVC) film.

5. The automobile roof panel of claim 1, wherein the second protective film includes at least one film selected from the group consisting of a polyethylene terephthalate (PET) film, a polycarbonate (PC) film, a polyethylene naphthalate (PEN) film, a polyimide (PI) film and an acrylic film.

6. (canceled)

7. The automobile roof panel of claim 1, wherein the second protective film is an embossed film.

8. The automobile roof panel of claim 1, wherein the outer protective film includes at least one film made of polyethylene (PE) based materials selected from the group consisting of polyvinyl chloride (PVC), an ethylene-vinyl acetate copolymer (EVA), high density polyethylene (HDPE), low density polyethylene (LDPE), linear low density polyethylene (LLDPE) and very low density polyethylene (VLDPE).

9-10. (canceled)
